(19) United States
(12) Patent Application Publication
(10) Pub. No.: US 2013/0069956 A1
(43) Pub. Date: Mar. 21, 2013

(54) Transforming Time-Based Drawings

(71) Applicant: David Tristram, San Jose, CA (US)

(72) Inventor: David Tristram, San Jose, CA (US)

(21) Appl. No.: 12/475,207

(22) Filed: May 29, 2009

(51) Int. Cl. G06T 15/70

(52) U.S. Cl. 345/473

(57) ABSTRACT

A method performed by a data processing apparatus, in which the method includes determining multiple first temporal coordinates, while receiving input defining a drawing from an input device, the drawing including multiple first object location coordinates received during a time period, in which each first temporal coordinate is based on a time when a respective one of the first object coordinates was received, receiving an input defining an animation period, applying a transformation to the first temporal coordinates to provide multiple transformed temporal coordinates respectively corresponding to the first image location coordinates, and periodically generating, based on the animation period, an animation by drawing the first object location coordinates according to the respective transformed temporal coordinates. Other embodiments of this aspect include corresponding computing platforms and computer program products.

### BACKGROUND

In general, computer-based drawing applications enable a user to generate structures, graphics or illustrations as static objects which then are output to a display. In some cases, those structures, graphics or illustrations can be animated by generating copies of the original objects, applying geometric transformations (such as translating, rotating and scaling, among others) to the copied objects, and displaying the transformed objects sequentially in time.

### SUMMARY

This specification describes technologies relating to transforming time-based drawings. In general, one aspect of the subject matter described in this specification can be embodied in a method performed by a data processing apparatus, in which the method includes determining multiple first temporal coordinates while receiving input defining a drawing from an input device, the drawing including multiple first object location coordinates received during a time period, in which each first temporal coordinate is based on a time when a respective one of the first object coordinates was received. The method further includes receiving an input defining an animation period, applying a transformation to the first temporal coordinates to provide multiple transformed temporal coordinates respectively corresponding to the first object location coordinates, and periodically generating, based on the animation period, an animation by drawing the first object location coordinates according to the respective transformed temporal coordinates. Other embodiments of this aspect include corresponding computing platforms and computer program products.

These and other embodiments can optionally include one or more of the following features. The multiple first object location coordinates can represent one or more locations in two-dimensional or three-dimensional image space. The transformation of the first temporal coordinates can be applied in response to a user-initiated command received by the data processing apparatus. Applying the transformation can include scaling, translating and/or rotating at least one or more of the first temporal coordinates.

In some implementations, the method can include generating one or more second temporal coordinates and interpolating, for each of the one or more second temporal coordinate, a respective second object location coordinate, in which generating the animation includes drawing the one or more second object coordinates according to the respective second temporal coordinate. In some cases, the method can include receiving an input defining a rate at which the plurality of first temporal coordinates are determined.

Particular embodiments of the subject matter described in this specification can be implemented so as to realize one or more of the following advantages. For example, the application allows, in some cases, a user to simultaneously interact with an animation as it is displayed without a visual abstraction, such as a timeline, scripting window or user interface icon, interfering with or visible during the animation. Accordingly, a user can visually observe instantaneous feedback as the appearance of an animated object is altered. In some implementations, the application enables a user to generate animations that are tied to rhythmic relationships in a corresponding musical soundtrack.

The details of one or more embodiments of the subject matter described in this specification are set forth in the accompanying drawings and the description below. Other features, aspects, and advantages of the implementations will become apparent from the description, the drawings, and the claims.

### BRIEF DESCRIPTION OF THE DRAWINGS

FIG. 1A shows an example of a user interacting with a time-based drawing application.

FIGS. 1B-1E show examples of objects produced by a time-based drawing application.

FIG. 2 illustrates an example of a system programmed to allow a user to perform transformations of time-based drawings.

FIG. 3 shows an example of a process applied by a time-based drawing application.

FIGS. 4A-4D show examples of rotating temporal coordinates of objects.

FIGS. 5A-5B show examples of scaling temporal coordinates of objects.

FIGS. 6A-6D show examples of translating temporal coordinates of objects.

FIGS. 7-11 show examples of objects rendered in a drawing space.

### DETAILED DESCRIPTION

In general, computer-generated animations are produced by applying the geometric transformations off-line, i.e., the intended client or audience does not observe the production of the animated feature. Nor does the act of producing of the animation typically correspond to the finalized end product that will be viewed by an audience.

In some implementations, a user or artist may be interested in producing a visual performance in which the temporal aspects of the objects, such as frequency, periodicity or phase, are altered as the objects are created. In addition, the user or artist may be interested in synchronizing such animations with a particular tempo, rhythm, soundtrack or music as part of the visual performance.

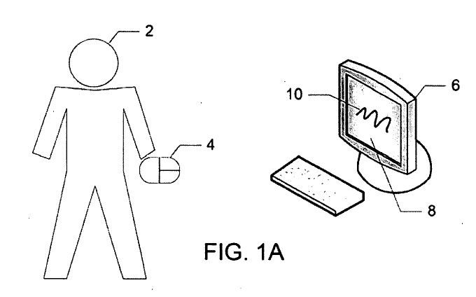

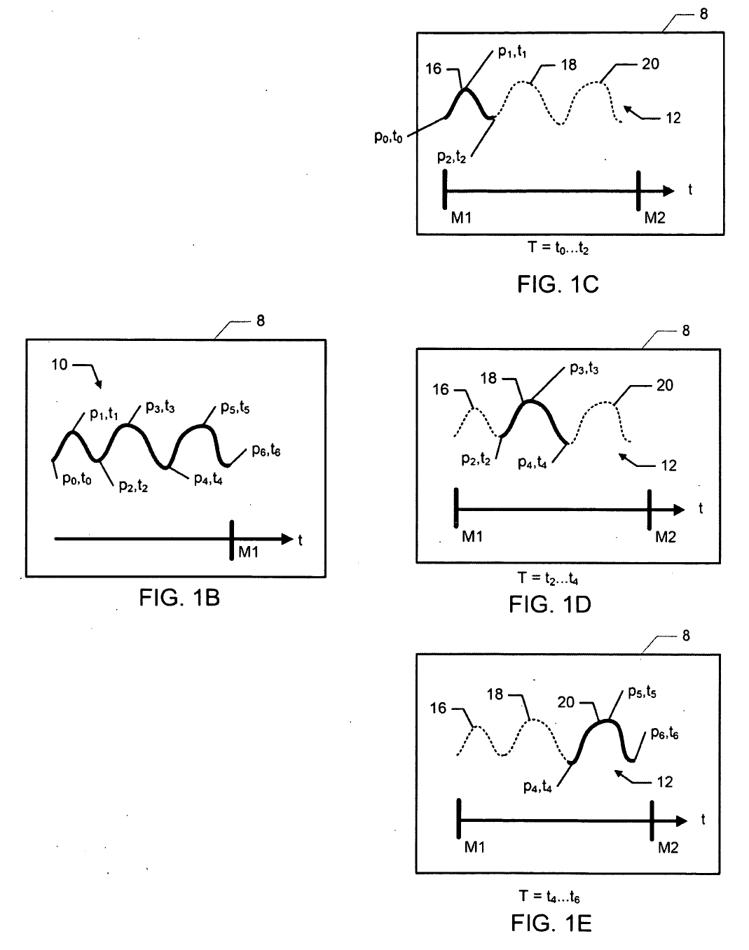

FIG. 1A shows an example of a user 2 interacting with a time-based drawing application configured to run on a computer 6. FIG. 1B shows an example of a drawing space 8 produced by the time-based drawing application. User 2 interacts with the drawing application through the aid of a user input device 4 that includes, for example, a computer mouse, keyboard, trackball, stylus or other pointing device. Employing user input device 4, user 2 provides input to the drawing application in order to create an object 10, such as, for example, a line, shape or other graphic, which then is output to a drawing space 8 on a display 9 of computer 6 as shown in FIG. 1B.

As object 10 is output to drawing space 8, the drawing application captures the geometric coordinates of object 10 on drawing space 8 as well as temporal coordinates that correspond to the time at which the respective geometric coordinates are captured. The rate at which the temporal and geometric coordinates are captured can be synchronized with a particular tempo/rhythm established by user 2, extracted from a file, or extracted from another software application, such as a video player or audio player. In the present implementation, the captured geometric and temporal coordinates of object 10 are stored in computer-readable memory as a dataset.

The user then can direct the drawing application to apply various transformations, such as scaling, translating and rotating, to the geometric and/or temporal coordinates of the stored dataset. Alternatively, the application can apply the transformations automatically. The transformed dataset then can be re-drawn, one or more times, by the drawing application as a new object 12. For example, FIGS. 1C-1E show new object 12 rendered in a drawing space 8 produced by a time-based drawing application 2. When new object 12 is drawn, the application re-traces both the motion and time evolution of the original object. User 2 can modify the new object's phase, rate, visibility or periodic attributes to provide a performance-based mechanism for creating artwork.

In the implementation of FIGS. 1B-1E, object 10 is shown as a free form curved line. Object 10 is not limited to a line, however, and can include other paths, shapes, text, or graphics. Furthermore, transformations applied by the time-based drawing application are not limited to affine transformations of temporal coordinates. For example, in response to a user initiated command, the time-based drawing application can modify text characteristics during animation, in which the modifications include, but are not limited to, changing font size, orientation, and style (e.g., bold, italic, underline, strikethrough, superscript, subscript). In some cases, the time-based drawing application can modify video playback characteristics, in response to a user initiated command. For example, user 2 can direct the time-based drawing application to modify the frame rate of a video being displayed in the time-based application. Alternatively, or in addition, user 2 can direct the time-based drawing application to perform other functions such as, re-displaying a video clip in a loop, lengthening or shortening how long a video-clip is displayed in the application, and re-positioning a video-clip within the application interface. Similarly, in some implementations, the time-based drawing application can manipulate audio files playing within the application in response to a user initiated command. For example, user 2 can direct the application to modify the playback rate of an audio file that is playing along with the animation. Alternatively, or in addition, the time-based drawing application can re-play the audio file in a loop along with the animation, adjust volume, or adjust a gain level corresponding to a particular range of audio frequencies. In some implementations, the time-based drawing application can apply changes to images, such as jpeg, tiff, png and gif images, that are displayed in the animation. For example, such changes include re-locating the position of an image as displayed in the time-based drawing animation or increasing or decreasing the size of an image as displayed in the time-based drawing animation. Alternatively, or in addition, such changes can include blurring, sharpening, skewing, brightening, modifying transparency, or rotating as the image is displayed in the animation. Each of the foregoing transformations can be applied in response to the dynamic motion of input device 4 as controlled by user 2. In addition, the foregoing examples are not exhaustive as other transformations may be applied as well.

As shown in the example of FIG. 1B, object 10 is composed of a set of coordinates p, in which each coordinate p represents the geometric position of object 10 on drawing space 8. For example, p could be representative of object 10 in Cartesian coordinates. That is, p₀=(x₀, y₀), p₁=(x₁, y₁) . . . pₙ=(xₙ, yₙ), where xₙ and yₙ respectively correspond to points along orthogonal axes of a plane. Alternatively, p can correspond to geometric coordinates of object 10 in another coordinate system such as a spherical, cylindrical or polar coordinate system. The total number of coordinates p which are representative of object 10 is determined by the final size of object 10 drawn by the user, as well as by the rate at which the drawing application captures each coordinate p. In addition to capturing the geometric position of object 10 as it is drawn, the drawing application also captures the time t at which each coordinate p is captured. That is, the initial position p₀ of object 10 is captured at t=t₀, the next position p₁ is captured at t=t₁ and so forth until the final position pₙ is captured at t=tₙ. Both the geometric coordinates p and the temporal coordinates t of object 10 then can be stored as a dataset in memory of computer 6.

Once the geometric and temporal coordinates of object 10 are captured, the application automatically re-draws an animated version of object 10 as new object 12 on drawing space 8 in time, as shown in FIGS. 1C-1E. In some cases, new object 12 includes one or more transformations, such as rotation, scaling and translation, which have been applied to the temporal coordinates of object 10. The transformations may be applied to the geometric coordinates as well. In some implementations, new object 12 is identical to object 10 as drawn by the user. Alternatively, in some cases, only portions of object 10 are re-drawn as part of new object 12. Although the application is described above as automatically animating and applying transformations in-time, a user 2 also can initiate, through an input device, the application of transformations to temporal coordinates (and/or geometric coordinates) at any point during the animation. Thus, it is possible for a user to interact concurrently in time with both the temporal and geometric aspects of an animation.

In the implementation shown in FIGS. 1C-1E, object 10 is re-drawn over time on drawing space 8. The geometric coordinates p of the object 10 are displayed in time according to the corresponding temporal coordinates t. In this example, however, only portions of object 10 are visible on drawing space 8 at any one time. Accordingly, object 10 in FIGS. 1C-1E is represented by a combination of solid and dashed lines, in which the solid line represents the visible portion of object 10 and the dashed line represents the portion of object 10 that is not displayed to the user.

During a first time period t₀-t₂, as shown in FIG. 1C, a first portion 16 of object 10, including coordinates p₀-p₂, is re-drawn to drawing space 8. Each coordinate p of first portion 16 is displayed in time according to the corresponding temporal coordinate (t₀-t₂). During the time period t₀-t₂, the remaining portions 18, 20 of object 10 are not visible on drawing space 8. During the second time period (t₂-t₄), as shown in FIG. 1D, second portion 18 of object 10 begins to appear on drawing space 8 as first portion 16 begins to disappear. Alternatively, first portion 16 may remain visible to the user or may disappear entirely as second portion 18 begins to appear. Each coordinate (p₂-p₄) of second portion 18 is displayed in time according to the corresponding temporal coordinate (t₂-t₄). In addition, third portion 20 of object 10 is not yet displayed. During the third time period (t₄-t₆), as shown in FIG. 1E, third portion 20 begins to appear on drawing space 8 as second portion 18 begins to disappear. Alternatively, second portion 18 and/or first portion 16 may remain visible to the user or may disappear entirely as third portion 20 begins to appear. Each coordinate (p₄-p₆) of third portion 20 is displayed in time according to the corresponding temporal coordinate (t₄-t₆).

In some implementations, the drawing application repeatedly renders object 10 as shown in FIGS. 1C-1E. That is, the motion and time evolution of object 10 are reproduced in a periodic manner. The period of repetition can be controlled by the user or, in some cases, extracted from a source having sound produced in a repeatable manner, such as the length of a measure in a musical soundtrack.

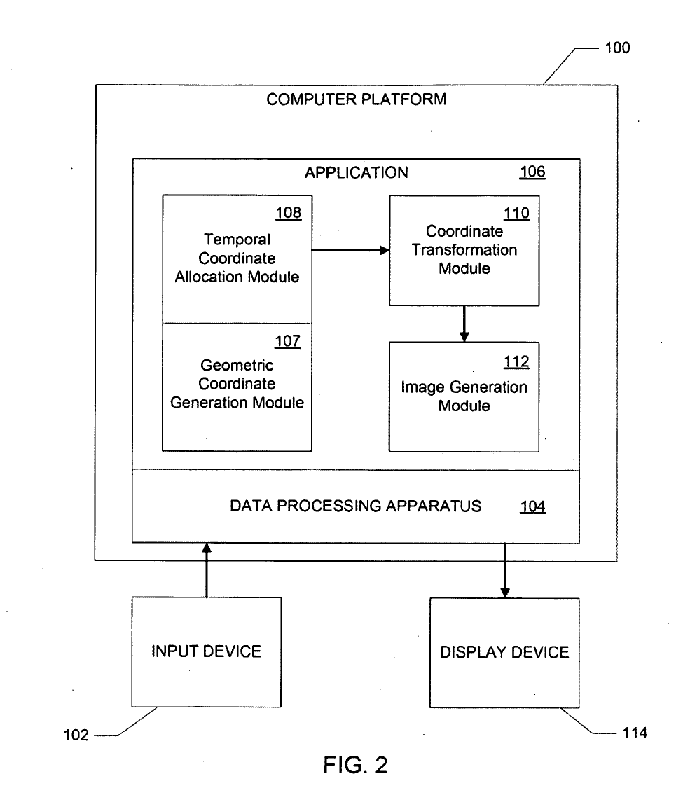

Referring to FIG. 2, an example of a system programmed to allow a user to perform transformations of time-based drawings, as in the example of FIGS. 1B-1E, is shown. The system can include a computer platform 100, an input device 102 and a display device 114. The computer platform 100 can include a data processing apparatus 104 and one or more programs, including a time-based drawing application 106. The time-based drawing application 106 operates, in conjunction with the data processing apparatus 104, to effect various operations described in this specification. The data processing apparatus 104 can include hardware/firmware, such as one or more processors, on which an operating system (OS) is configured to run (e.g., Windows® OS, MAC® OS, or Linux® OS), and at least one computer-readable media (e.g., random access memory or storage device). Thus, the application 106, in combination with processor(s) and computer-readable media of the data processing apparatus 104, represents one or more structural components in the system.

The time-based drawing application 106 can be an image processing application or a portion thereof. As used herein, an application refers to a computer program that the user perceives as a distinct computer tool used for a defined purpose. An application can be built entirely into the OS of the data processing apparatus 104, or an application can have different components located in different locations (e.g., one portion in the OS and one portion in a remote server connected to the platform 100), and an application can be built on a runtime library serving as a software platform of the data processing apparatus 104. The time-based drawing application 106 can include image editing software, digital publishing software, video editing software, presentation and learning software, and graphical/text editing software (e.g., Adobe® Photoshop® software, Adobe® InDesign® software, Adobe® Captivate® software, Adobe® AfterEffects® software, Adobe® Premiere®, Adobe® Flash Pro® and Adobe® Illustrator® software, available from Adobe Systems Incorporated of San Jose, Calif.). The user input device(s) 102 can include, for example, keyboard(s) and a pointing device, such as a mouse, trackball, stylus, or any combination thereof. The display device(s) 114 can include a display monitor capable of producing color or gray scale pixels on a display screen. For example, the display device(s) can include a cathode ray tube (CRT) or liquid crystal display (LCD) monitor for displaying information to the user. The computer platform 100, the input device 102 and the display device 114 can together be included in a single system or device, such as a personal computer, a mobile telephone, a personal digital assistant (PDA), a mobile audio player, to name just a few.

As shown in FIG. 2, the time-based drawing application 106 includes a geometric coordinate module 107 for generating geometric coordinates based on input data provided by the user input device 102. The application 106 also includes a temporal coordinate module 108 that captures the time at which a corresponding geometric coordinate was generated by the geometric coordinate module 107. A coordinate transformation module 110 applies one or more transformations to the geometric and/or temporal coordinates. An image generation module 112 produces an image based on the transformed geometric and/or temporal coordinates and outputs the image to the display device 114.

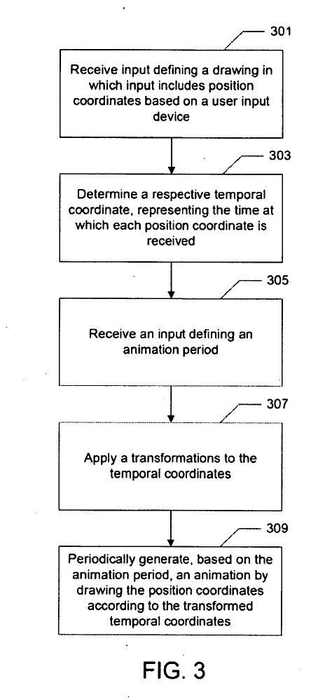

FIG. 3 shows an example of the process applied by the time-based drawing application 106. Employing user input device 102, a user draws object 10, such as, for example, a line, path, shape or other graphic within a drawing space provided on the display device 114 by the time-based drawing application. The style, color, and visibility of object 10 depend on the object properties available within the time-based drawing application as selected by the user. The user may select the image display properties from a legend made visible on the display by the time-based application or through the use of commands entered from input device 102.

As object 10 is drawn, geometric coordinate module 107 receives (301) position coordinates (i.e., image location coordinates) from the input device 102 based on a position indicated by user input device 102. For each position coordinate, temporal coordinate module 108 determines (303) a respective time coordinate, representing the time at which the position coordinate is received. The application may also receive (305) an input which defines an animation period. The input may be entered from user input device 102 or extracted from a file by the drawing application. Coordinate transformation module 110 then applies (307) one or more transformations to the temporal coordinates to provide transformed temporal coordinates respectively corresponding to the position coordinates. The type of transformation applied to the position and/or temporal coordinates of the first dataset can be determined by the user. Such transformations include, but are not limited to, for example, rotation, translation and scaling of coordinates as well as affine transformations such as skew or perspective transformations. Alternatively, or in addition, such transformations can be automatically applied by time-based drawing application 106. The position coordinates then are sent to the image generation module 112 which periodically generates (309), based on the received animation period, an animation by drawing the position coordinates according to the respective transformed temporal coordinates. When displaying lines, paths or other shapes that are displayed without a discontinuity, the time-based drawing application can interpolate portions of the object that are displayed between the position coordinates.

The style, color, and visibility of the image output to display device 114 depend on the object properties available within time-based drawing application 106 as selected by the user. For example, the user may direct time-based drawing application 106 to alter the color, size and/or visibility of all or part of the output image as it is animated on the display. The user may select the image display properties from a legend made visible on the display by the time-based application or through the use of commands entered from a keyboard.

The total number of position coordinates captured by the time-based drawing application depends on the final size of the object drawn by the user as well as the rate at which the drawing application captures each position coordinate. For example, in some implementations, a user may utilize input device 102, such as a mouse, to indicate the beginning of a curved path on a drawing space by holding down the left-click button of the mouse. While the left-click button is depressed, the time-based drawing application periodically records the position coordinate as indicated by the position of the mouse. Once the user releases the left-click button, the time-based drawing application ceases to record the position coordinates.

Employing user input device 102, the user can set the rate at which time-based drawing application 106 captures and assigns temporal coordinates to the position coordinates of the drawing. In some implementations, animations produced by time-based drawing application 106 can be rendered in a repeated (i.e., periodic) manner. For the purposes of this disclosure, the period of repetition will be referred to as a measure. Thus, employing user input device 102, the user also can set the length of a measure. For example, the user may enter the rate and/or length of a measure as a numeric value measured in micro-seconds, milliseconds, seconds or minutes. Other units of time-based measurement may be used as well. In some cases, time-based drawing application 106 may extract a rate/length of a measure from a rhythm established by the user. For example, a user may establish a tempo by tapping a key on a keyboard of input device 4 in a periodic manner. The rate at which the key is tapped establishes the tempo and is recorded by the time-based drawing application. In some cases, the tempo and/or length of a measure can be extracted from another software application. For example, the time-based drawing application can extract a tempo and/or length of a measure from an audio player, such as a musical instrument digital interface (MIDI) sequencer, that plays a selected audio file. Alternatively, or in addition, the time-based drawing application can extract a tempo and/or length of a measure from a video player in which periodic behavior or motion is recognized and captured in a video. In some implementations, the user identifies a source file from which time-based drawing application 106 extracts a tempo and/or length of a measure. For example, the user can select, through time-based drawing application 106, an electronic file, such as an audio file, from memory or from a computer-readable storage device. The audio file can include music or other sound organized in a periodic manner from which a tempo and/or length of a measure can be extracted. Such audio files can include, for example, WAV, AIFF, AU, WMA, MP3 and AAC files, among others.

The animations produced by time-based drawing application 106 also can be rendered in a repeated (i.e., periodic) manner. For the purposes of this disclosure, the period of repetition will be referred to as a measure. The measure can be specified by the user. For example, the user can enter the period as a numeric value measured in micro-seconds, milliseconds, seconds or minutes. In some implementations, the length of a measure may be represented as a number of beats, where beats are understood to appear at a certain rate such as beats per micro-second, millisecond, second, or minute. Other units of time-based measurement may be used as well. In some cases, the period can be extracted by the time-based drawing application 106 from a separate file or another software application. For example, in some cases, the application 106 defines a measure by analyzing an associated audio file to determine the length of the measure at a specified tempo.

Drawing space 8, on which objects are formed, can be a blank image space produced on display 9 by time-based drawing application 106. A user can select various drawing tools, such as a line tool, brush tool, or shape tool, among others to draw objects in drawing space 8. In some implementations, drawing space 8 does not display any persistent tools, such as a pointer or cursor, or palettes from which a user may select, given that such images can detract from a viewer's attention from artwork or other objects being produced in the application. Instead, a user can change drawing tools using keyboard commands. In some implementations, a pointer icon remains visible to a user on the drawing space and can indicate which tool is in current use. For example, the icon can include images representative of tools such as a line drawing tool, a brush drawing tool, a shape drawing tool, among others. The pointer icon can also exhibit a color that is representative of the color to be used by the drawing tool. The pointer icon could exhibit a periodic motion or effects, such as rotating, throbbing, swinging similar to a pendulum, to indicate the current tempo associated with the animation or the period in which an object will be replicated. Other drawing effects also can be represented by the pointer icon appearance. In some cases, the pointer icon presages the type of object to be displayed. For example, the pointer icon may be in the form of a circle, triangle or square indicative of the object shape to be drawn. In some implementations, the icon can be representative of the one or more symmetry operations that will be applied to an animation. For example, if the transformation will produce multiple copies of an object, all of which are animated so that they rotate around a single point (i.e., radial symmetry), the icon can represent the radial symmetry transformation by displaying a specified number of line segments equally arranged about and radiating from a single point. The total number of line segments displayed could be representative of the number of objects rotating around the single point. Other icon shapes may be used as well.

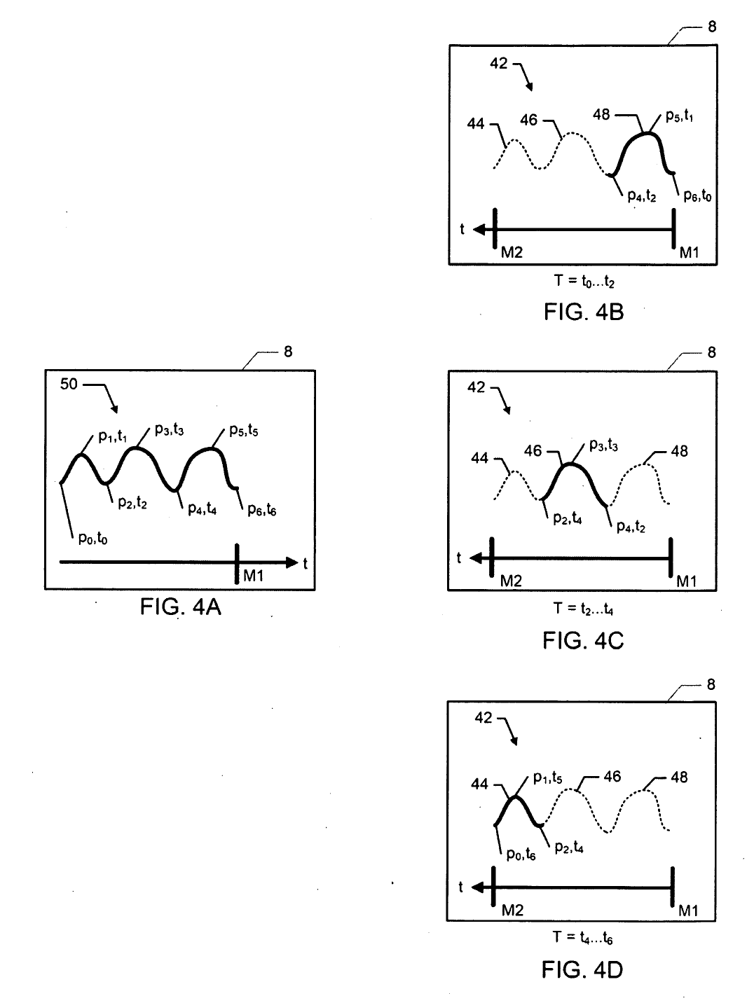

As explained above, images can be re-drawn in which transformations are applied to the temporal coordinates and/or geometric coordinates of the original image. In some implementations, the transformation includes rotating the coordinates. FIGS. 4A-4D show an example of an object, such as stroke 40, being re-drawn in which the temporal coordinates of stroke 40 are rotated 180 degrees.

As shown in FIG. 4A, stroke 40 is a free form curved stroke, although other paths, shapes or graphics can be used as well. As with the implementation shown in FIG. 1B, stroke 40 is composed of a set of coordinates including, but not limited to, coordinates p₀ . . . p₆, in which each coordinate p represents the Cartesian coordinate of stroke 40 on display 8. Parameter p may represent a coordinate in other coordinate systems, as well. Each parameter t₀ . . . t₆ in FIG. 4A represents a time at which a corresponding coordinate p is captured. That is, the initial position p₀ of stroke 40 is captured at t=t₀, the next position p₁ is captured at t=t₁ and so forth until the final position pₙ is captured at t=tₙ. In the present implementation, the time from t₀ to t₆ represents one measure M1. However, in some cases, the length of time over which the temporal coordinates are captured may be less than one total measure or extend over multiple measures. Both the geometric coordinates p and the temporal coordinates t of stroke 40 are stored in a first dataset in memory.

A user can direct the application to re-draw a version of stroke 40 in reverse from the final position coordinate p₆ to the first position coordinate p₀. That is, the drawing application transforms the temporal coordinates of the first dataset so they are reversed with respect to the geometric coordinates. The transformed temporal coordinates and geometric coordinates are stored in a second dataset. Beginning in the next measure, the second dataset is displayed over time as stroke 42, as shown in FIGS. 4B-4D.

During a first part of the measure (e.g., t₀-t₂), as shown in FIG. 4B, a first portion 44 of stroke 42, including coordinates p₆-p₄, is output to a display. Each coordinate p of first portion 44 is displayed in time according to the corresponding temporal coordinate (t₀-t₂). Accordingly, p₆ is displayed at t₀, p₅ is displayed at t₁ and p₄ is displayed at t₂. During the first part of the measure, the remaining portions 46, 48 of object 42, as indicated by the dashed lines, are not visible. During the next part of the measure (t₂-t₄), as shown in FIG. 4C, second portion 46 of stroke 42 begins to appear on display 8 as first portion 44 begins to disappear. Alternatively, first portion 44 may remain visible to the user or may disappear entirely as second portion 46 begins to appear. Each coordinate (p₄-p₂) of second portion 46 is displayed in time according to the corresponding temporal coordinate (t₂-t₄). In addition, third portion 48 of stroke 42 is not yet displayed. During the third part of the measure (t₄-t₆), as shown in FIG. 1E, third portion 48 begins to appear on display 8 as second portion 46 begins to disappear. Alternatively, second portion 46 and/or first portion 44 may remain visible to the user or may disappear entirely as third portion 48 begins to appear. Each coordinate (p₂-p₀) of third portion 48 is displayed in time according to the corresponding temporal coordinate (t₄-t₆).

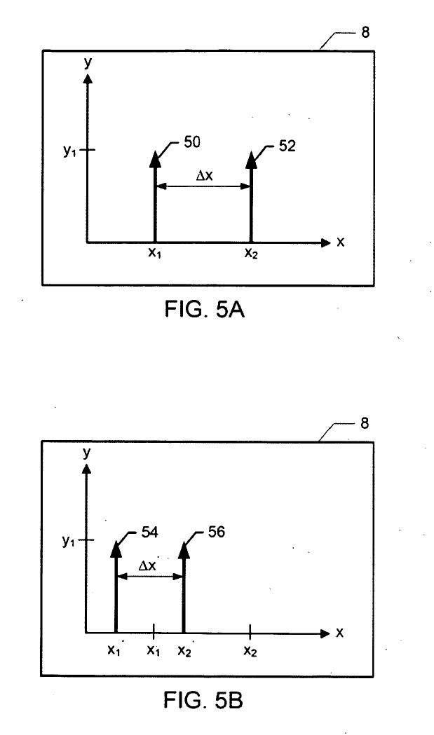

FIGS. 4A-4C illustrate an object being rotated 180 degrees in time. However, in some implementations, a rotation transformation can be applied in which the rotation effect is coupled to both temporal and geometric coordinates of an object. For example, FIGS. 5A-5B illustrate a rotation transformation in which the effect of rotation is coupled to the geometric and temporal coordinates of two separate objects 50, 52. As shown in FIG. 5A, each of the two objects 50, 52 correspond to a vertical arrow with the arrow head directed towards the top of drawing space 8. Object 50 is located along a horizontal axis x at location x₁ whereas object 52 is spaced apart from object 50 by a distance Δx and is located along the horizontal axis at x₂. Each of the objects 50, 52 also has an identical height y₁ as measured along a corresponding vertical axis y. Objects 50, 52 are simultaneously animated within drawing space 8 over time, with the animation starting from the arrow bottom and ending at the tip of the arrow head. The time period over which the objects 50, 52 are animated corresponds to a single measure, M, as established by the drawing application.

In the present implementation, a counter-clockwise rotation is applied to the geometric and temporal coordinates with respect to the vertical axis y located to the left of objects 50, 52. For example, to rotate objects 50, 52 counter-clockwise with respect to axis y, the x and t coordinates of objects 50, 52 can be matrix multiplied using the following rotation matrix:

R=[cos(θ)−sin(θ)|sin(θ)cos(θ)]

where θ is the angle of rotation. Thus, transformed objects will be located respectively at new positions x₁′ and x₂′ and have new time coordinates t₁′ and t₂′ where [x₁′, t₁′]=R*[x₁, t₁] and [x₂′,t₂′]=R*[x₂, t₂]. That is, the position and temporal coordinates of objects 52, 54 are given by:

x₁′=x₁*cos(θ)−t₁ sin(θ)

t₁′=x₁*sin(θ)+t₁ cos(θ)

x₂′=x₂*cos(θ)−t₂ sin(θ)

t₂′=x₂*sin(θ)+t₂ cos(θ)

As a result, the transformation rotates objects 50, 52 about an imaginary line that extends into the page and affects the horizontal spacing of objects 50, 52 but not their respective heights. Furthermore, the rotation will add an offset to the time at which the objects are rendered. For example, as shown in FIG. 5B, a counter-clockwise rotation of 45 degrees is applied to objects 50, 52 to obtain transformed objects 54, 56. The location of object 54 along the x-axis is given by x₁′=(√2/2)*x₁−(√2/2)*t₁ and the location of object 56 is given by x₂′=(√2/2)*x₂−(√2/2)*t₂. Thus, both objects are shifted to the left. Similarly, the new time coordinates for objects 54 and 56 are respectively given by t₁′=(√/2/2)*x₁+(√2/2)*t₁ and t₂′=(√2/2)*x₂+(√2/2)*t₂. Thus, if the time coordinates t₁, t₂ of objects 50, 52 are equal, the transformed object 56 will be rendered in drawing space 8 later in time than transformed object 54. As another example, rotating the objects 50, 52 by 180 degrees will result in a shift of objects 50 and 52 to the left of the y-axis. In addition, they will be rendered in time in reverse.

In some implementations, the rotation can be clockwise, instead of counter-clockwise. In some cases, the rotation transformation also is applied to the y-coordinates. FIGS. 5A-5B illustrate a two-dimensional rotation transformation applied to a three-dimensional object (i.e., two geometric dimensions and one temporal dimension). Higher dimensional rotation transformations can be applied as well. For example, a three-dimensional rotation transformation can be applied to a three-dimensional object (x, y and t) or a four-dimensional object (x, y, z and t). In some cases, a four-dimensional rotation can be applied to a four-dimensional object (x, y, z and t).

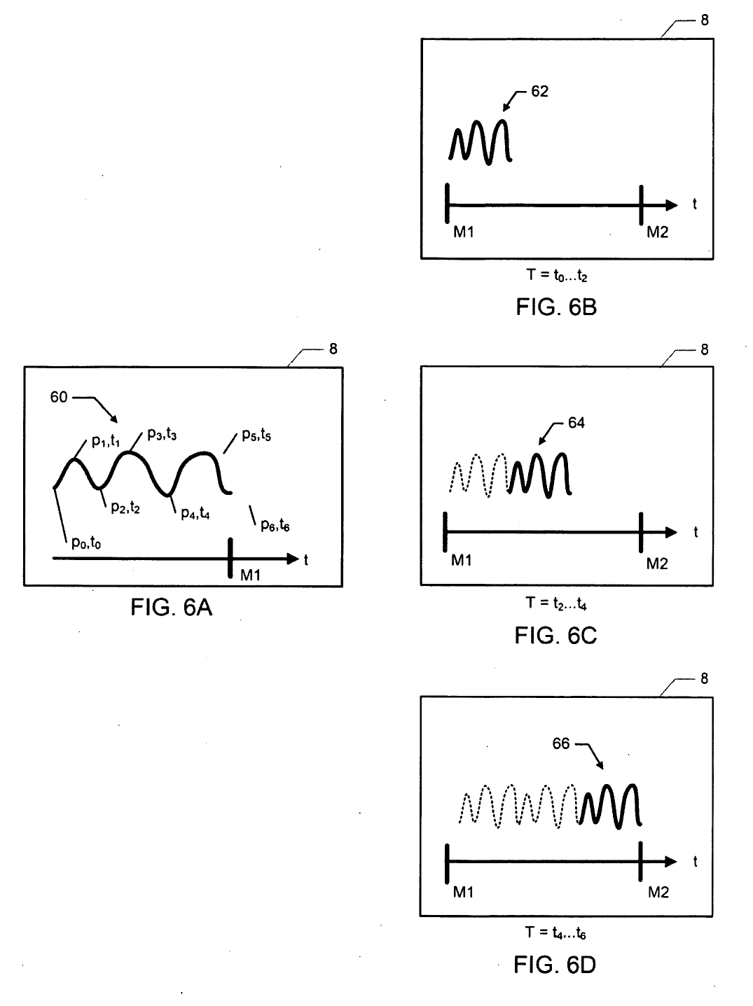

In some implementations, the temporal and/or geometric coordinates of an object can be scaled to be greater than or less than their original value. For example, FIG. 6A shows an object, such as stroke 60, rendered in drawing space 8 over time t, in which both geometric (p₀-p₆) and temporal (t₀-t₆) coordinates of stroke 60 are captured by a time-based drawing application. As shown in the example, stroke 60 is rendered over one full measure M1. The geometric and temporal coordinates then are stored in a first dataset in memory. The temporal coordinates of the first dataset then are transformed by scaling and stored, with the corresponding geometric coordinates, in a second dataset. For example, if the scaling reduces the value of the temporal coordinates, position coordinates of the new stroke are displayed earlier in time, such that the stroke is drawn faster in the second measure than original stroke 60 was in the first measure. Accordingly, in some implementations, the new stroke 62 may be drawn prior to the end of the second measure. FIG. 6B shows an example of the second dataset rendered in the next measure as new stroke 62, in which new stroke 62 begins at the end of measure M1 and is completely rendered prior to the end of measure M2. As shown in the example of FIG. 6B, only a period of time T=t₀−t₂ is necessary to render new stroke 62 in drawing space 8. In some cases, the application may render additional copies of the transformed stroke prior to the end of the measure. For example, FIGS. 6C and 6D respectively show new stroke 64 and 66 rendered in drawing space 8. New stroke 64 is rendered in the second measure during a period of time T=t₂−t₄. New stroke 64 is rendered in the second measure during a period of time T=t₄−t₆. The dashed lines shown in FIGS. 6C and 6D represent previous strokes that may or may not still be visible to a user in drawing space 8.

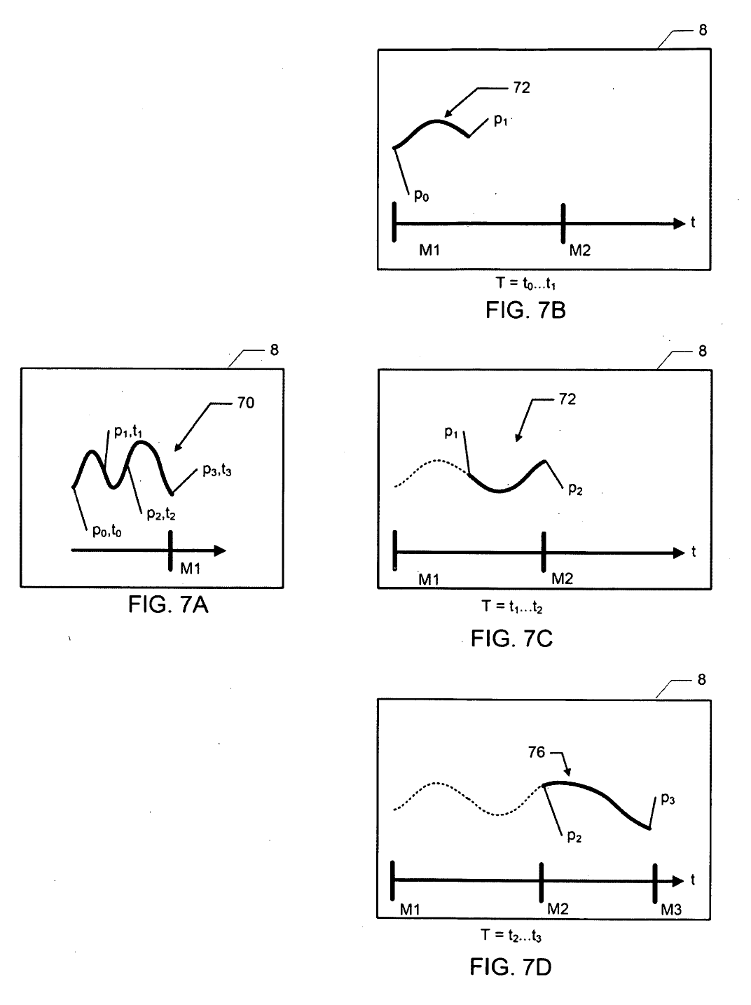

In some implementations, scaling increases the value of the temporal coordinates, such that position coordinates of the object take longer to be rendered to the drawing space. For example, FIG. 7A shows a stroke 70 having position coordinates p₀-p₃ rendered in drawing space 8, in which the time to render stroke 70 occupies one full measure M1. Stroke 70 can be re-drawn in the next measure as a new stroke in which the temporal coordinates have been scaled to a larger value than the temporal coordinates of stroke 70. For example, FIG. 7B shows a first portion of stroke 72 rendered in a second measure M2, in which stroke 72 includes temporal coordinates of stroke 70 that have been scaled. FIG. 7C shows a second portion of stroke 72 rendered in second measure M2. Thus, not all of stroke 72 will be drawn in second measure M2. In some implementations, the time-based drawing application will display the remaining position coordinates of stroke 72 beginning in a third measure that follows the second measure, as shown in FIG. 7D. In some implementations, another instance of stroke 72 also is re-drawn at the beginning of each new measure. Thus, if the scaling is large enough, new instances of stroke 72 will begin to be drawn in each measure even though the previous instance of stroke 72 has not finished being rendered by the time-based drawing application. Alternatively, the time-based drawing application will not display the remaining position coordinates of stroke 72. The dashed lines shown in FIGS. 7C and 7D represent previous strokes that may or may not still be visible to a user in drawing space 8.

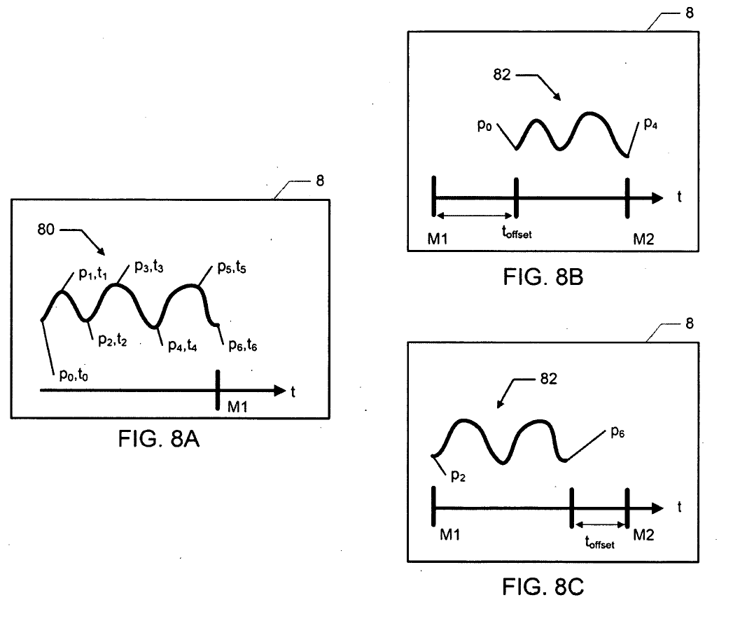

In some implementations, the transformation applied to geometric and/or temporal coordinates can be a translation. For example, FIG. 8A shows an object, such as stroke 80, viewed in time t, in which both geometric and temporal coordinates of stroke 80 are captured by a time-based drawing application and stored in a first dataset in memory. The temporal coordinates of the first dataset are translated by an amount Δt and stored, along with the geometric coordinates, in a second dataset. The second dataset then is rendered in drawing space 8 in measure M2 as stroke 82. Stroke 82 is identical to stroke 80 except that it has been translated by an amount Δt=t_{offset}.

If the translation amount Δt corresponds to a positive shift of the temporal coordinates, the initial position coordinate of stroke 82, p₀, will begin to appear later in the second measure corresponding to the shift amount, as shown in FIG. 8B. That is, p₀ will appear at t₀+Δt in the second measure. At the end of measure M2, stroke 82 has reached position coordinate p₄. Thus, not all of stroke 82 will be drawn in the second measure. In some implementations, the time-based drawing application will display the remaining position coordinates of stroke 82 beginning in a third measure that follows the second measure. Alternatively, the time-based drawing application will not display the remaining position coordinates of stroke 82.

If the translation amount Δt corresponds to a negative shift of the temporal coordinates, stroke 82 will appear earlier in the second measure corresponding to the shift amount, as shown in FIG. 8C. In the implementation shown in FIG. 8C, however, the appearance of stroke 82 will not begin with the initial position coordinate p₀. Instead, the position coordinate that first appears will depend on the amount of the negative shift provided by Δt. Accordingly, in some implementations, the time-based drawing application may finish displaying stroke 82 prior to the end of the second measure.

Although the foregoing transformations are described in relation to temporal coordinates, similar transformations can be applied concurrently to the geometric coordinates of each object. In addition, two or more of the foregoing transformations can applied in combination to achieve additional effects. For example, in some implementations, temporal and/or position coordinates of an object may be rotated and translated. Alternatively, or in addition, temporal and/or position coordinates of an object may be rotated and scaled. Alternatively, or in addition, temporal and/or position coordinates of an object may be translated or scaled. The transformations need not be affine transformations. Instead, any generalized transformation can be applied. For example, the transformation may entail translating every third coordinate in an array of temporal or geometric coordinate by a fixed amount. Additional combinations of coordinate transformations also are possible. Thus, using the foregoing transformations, it is possible for a user to alter the temporal aspects of a drawing or object as desired.

Such transformations also allow a user, in some cases, to adjust the time evolution of a drawing so that it synchronizes with an associated musical soundtrack. For example, the phase of one or more objects can be adjusted to synchronize the initial position of those objects with a semantically meaningful moment in the associated soundtrack, such as the downbeat of a measure. In some cases, a user can modify or refine the evolution of drawings or objects by changing their specific rate, position or appearance relative to the evolution of other objects being displayed within the application. A user can add additional objects to build up a collection of objects that are displayed and evolve in time in the application.

Hierarchical Representation of Time

In some implementations, the drawing application utilizes a global clock for displaying animations in the drawing space. The global clock corresponds to a master clock against which one or more animations proceed and is distinct from the time coordinates associated with each animated object. The global clock determines how the time coordinates of each object are interpreted. As a result, a change in the rate of the global clock changes simultaneously the rate of change of the appearance of every animating object within the drawing application.

In some cases, the rate established by the global clock also corresponds to the rate at which the application captures position coordinates of an object that is drawn by a user. As explained above in reference to FIG. 1, the geometric coordinate module 107 in the drawing application captures position coordinates based on a position indicated by the user input device 102. For each position coordinate, temporal coordinate module 108 captures a respective time coordinate, representing the time at which the position coordinate is captured. The value of each captured time coordinate is determined by the global clock. The frequency of the global clock can be entered by the user through the input device or it can be extracted by the time-based drawing application 106.

In addition, however, each object and/or group of objects rendered by the time-based drawing application also can be associated with a local clock that provides a local representation of time t₁. Local clock t₁ determines a temporal state of the object and/or a group of objects in relation to the global clock t_{g}. Local clock t₁ does not, however, correspond to a mere multiplication of the global time coordinates by a scaling factor. Instead, local clock t₁ is determined by modifying its instantaneous rate of change relative to global clock t_{g}. By associating a local clock with each object and/or group of objects, the rate at which each object and/or group of objects is animated, or is evolving, can be changed without causing a discontinuity in the appearance of the object and/or group of objects. That is, each object has a local sense of how time advances that is independent of a change in the rate of the local clock time. Moreover, by associating a local clock with each object, it is possible to modify the rate of animation of each object within the drawing application and, at the same time, maintain the relative rate differences in which each object is animated.

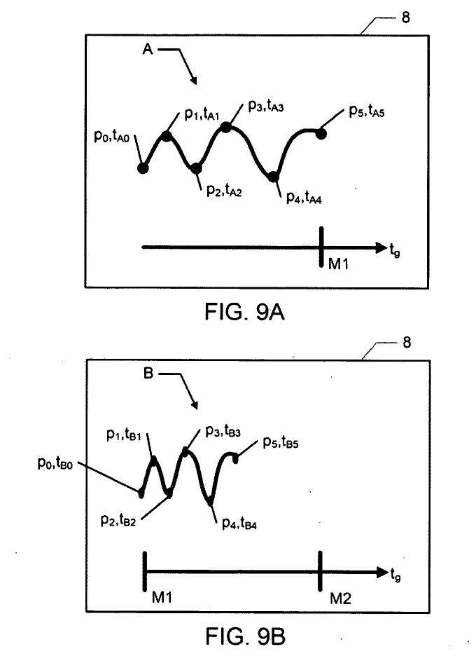

FIG. 9A shows an example of rendering an object in a drawing space 8 using a drawing application that represents time hierarchically. Drawing space 8 includes object A in which each of the position coordinates (p₀-p₅) of object A is rendered at a corresponding time represented by a temporal coordinate (e.g., t₀-t₅). As shown in the example of FIG. 9A, object A is rendered in a time period equal to one measure M1, in which measure M1 is determined using a global clock t_{g} that runs for all objects in drawing space 8. In the present implementation, object A also is associated with a local clock t_{A} that advances at a rate relative to global clock t_{g}. The values of local clock t_{A} in terms of global clock t_{g} are given as follows:

t_{A0}=t_{g0}; t_{A1}=t_{g0}+r_{A}*Δt; t_{A2}=t_{A1}+r_{A}*Δt; . . . t_{A5}=t_{A4}+r_{A}*Δt,

in which r_{A} represents how fast the local clock t_{A} proceeds relative to the global clock t_{g} and Δt represents the time difference between each temporal coordinate as determined by the global clock. For example, if local clock t_{A} advances at a rate equal to global clock t_{g}, then r_{A}=1 and the time coordinates of the local clock can be given as: t_{A0}=t_{g0}; t_{A1}=t_{g0}+Δt=t_{g1}; t_{A2}=t_{g1}+Δt=t_{g2}; . . . t_{A5}=t_{g4}+Δt=t_{g5}. Accordingly, there is no change in the rate at which object A is rendered in drawing space 8. Table 1 represents the values (in seconds) of the global clock t_{g} and local clock t_{A}, corresponding to the respective position coordinates of object A, in which the local clock t_{A} proceeds at a rate equal to the global clock t_{g}, i.e., r_{A}=1, and a time difference Δt=1.

TABLE 1

| | Position Coordinate p | | | | | |
|---|---|---|---|---|---|---|
| | p₀ | p₁ | p₂ | p₃ | p₄ | p₅ |
| Global Clock | 0 | 1 | 2 | 3 | 4 | 5 |
| t_{g} (sec) | | | | | | |
| Local Clock | t_{A0} = | t_{A1} = | t_{A2} = | t_{A3} = | t_{A4} = | t_{A5} = |
| t_{A} (sec) | t_{g0} = 0 | t_{g1} = 1 | t_{g2} = 2 | t_{g3} = 3 | t_{g4} = 4 | t_{g5} = 5 |

In contrast, by employing a local clock having a rate that is different from the global clock, it is possible, in some implementations, to change the rate at which an object is rendered in the drawing space 8 without inducing a discontinuity in the animation. FIG. 9B shows an example of rendering an object B in a drawing space 8 using a drawing application that represents time hierarchically. Object B is rendered in drawing space 8 in a time period equal to measure M2, which begins at the end of measure M1. As in FIG. 9A, the length of measure M2 is determined using global clock t_{g}. The position coordinates of object B are identical to object A except that the local clock associated with object B proceeds at a rate twice as fast as the global clock. For example, the user may have entered a command through a user input device which instructs the drawing application to render object B in the display twice as fast as the rate for at which object A is rendered. Thus, the rate of progression of local clock t_{B} for object B relative to global clock t_{g} is r_{B}=2. The values of the local clock t_{B} in terms of global clock t_{g} then can be expressed as:

t_{B0}=t_{offset}; t_{B1}=t_{B0}+(2)*Δt; t_{B2}=t_{B1}+(2)*Δt; . . . t_{B5}=t_{B4}+(2)*Δt,

in which t_{offset} is equal to t_{g5}, i.e., the end of measure M1 according to the global clock t_{g}. Accordingly, object B is rendered in half the time that it takes to render object A. Table 2 represents the values of the global clock t_{g} and local clock t_{B}, corresponding to the respective position coordinates of object B, in which the local clock t_{B} proceeds at a rate that is twice that of the global clock t_{g}, i.e., r_{B}=2.

TABLE 2

| | Position Coordinate p | | | | | |
|---|---|---|---|---|---|---|
| | p₀ | p₁ | p₂ | p₃ | p₄ | p₅ |
| Global Clock | 0 | 1 | 2 | 3 | 4 | 5 |
| t_{g} (sec) | | | | | | |
| Local Clock t_{B} | t_{B0} = 0 | t_{B1} = 2 | t_{B1} = 4 | t_{B2} = 6 | t_{B3} = 8 | t_{B4} = 10 |
| (sec) | | | | | | |

In some implementations, the rate of progression of the local clock relative to the global clock can be decreased. In those cases, rendering of the object occurs over longer periods of time. For example, the rate of progression of local clock t_{B}, for an object B taking twice as long to render as object A, is r_{B}=1/2. In this case, rendering of object B may occur over 2 or more measures.

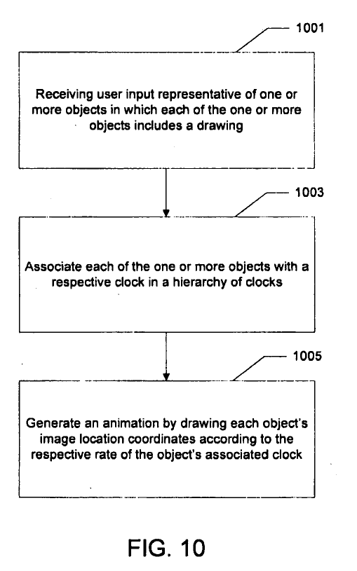

FIG. 10 illustrates an example process of how a time-based drawing application animates objects using hierarchical representations of time. Upon receiving (1001) user input representative of one or more objects, in which each object includes a drawing defined by multiple image location coordinates and temporal coordinates that respectively correspond to the image location coordinates, the time-based drawing application associates (1003) each animation with a respective clock in a hierarchy of clocks. Each clock in the hierarchy has a respective rate that is determined relative to one or more parent clocks in the hierarchy. The image location coordinates of each object then are rendered (1005) in the drawing space according to the respective rate of the clock associated with the object. The rate at which each clock advances can be set by user input or, alternatively, according to presets established in the time-based drawing application. When more than one object is rendered in a drawing space, the objects can be animated simultaneously or in a sequential order.

In some implementations, objects can be nested within other objects. For example, one or more objects (i.e., children objects) can be nested within a parent object, in which each child object has its own local clock that advances at a rate relative to a local clock associated with the parent object. In some cases, the parent object, itself, can be nested as a child object within a second parent object, in which the local clock associated with the child object advances at a rate relative to a local clock associated with the second parent object. Accordingly, each object can be represented as part of a hierarchy of objects and each clock can be represented as part of a hierarchy of clocks. Ultimately, each local cock in the hierarchy advances at a rate that is relative to its parent, and hence, relative to the global clock of the time-based drawing application. The number of objects, and thus clocks, that can be nested within a hierarchy is limited only by the memory components of the computer system on which the time-based drawing application runs.

In some implementations, two or more objects can be incorporated into a group such that the group of objects is associated with its own local group clock. In addition, the local clocks associated with each object within the group continue to advance relative to the group clock. Furthermore, the group may be combined with one or more different objects or groups into an even larger second group that also is associated with a respective local group clock.

The rate at which each clock advances, for a single object or for a group of objects, is relative to the progression of time set by its parent, and hence, the global clock. Accordingly, in the case that objects are nested (e.g., an object A is the child of parent object B which, in turn, is the child of parent object C), the effective rate at which a local clock progresses for a particular object or group, in terms of the global clock, is determined by aggregating the rates of each clock in the lineage. For example, the effective rate associated with object A above is r_{eff}=r_{A}*r_{B}*r_{C}. On the other hand, the effective rate for object B is r_{eff}=r_{B}*r_{C}. Thus, the notion of time in the drawing application is hierarchical.

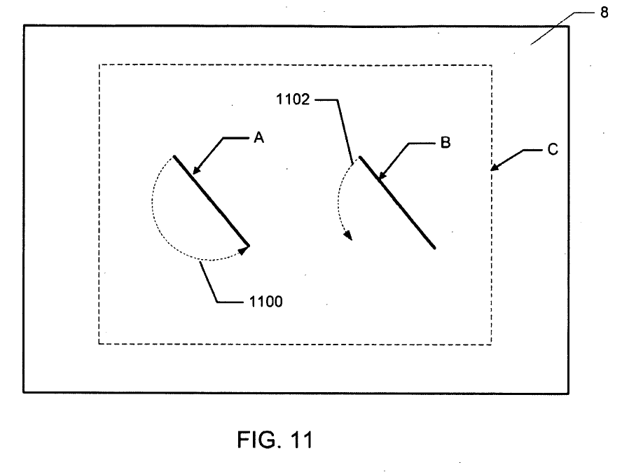

FIG. 11 shows examples of objects A, B and C rendered in drawing space 8 versus time. Each of objects A and B corresponds to a line rotating counter-clockwise in a circle. The path of rotation for objects A and B is illustrated by dashed lines 1100 and 1102. Both objects A, B are associated with a respective local clock. The rate at which the local clock t_{A} advances is twice as fast as the rate at which local clock t_{B} advances. Thus, object A appears to rotate twice as fast as object B when rendered in drawing space 8.

Both objects A and B are grouped such that they can be translated, scaled and/or rotated across the drawing space 8 as a single object C. Object C is associated with its own local clock t_{C}. The local clock for object C advances at a rate r_{C} relative to the global clock t_{g}. Each of the objects A and B within object C remains associated with their respective local clocks t_{A} and t_{B} which proceed according to the respective rates r_{A} and r_{B}. Thus, the effective rate at which object A is animated, in terms of the global clock, is given by r_{eff}=r_{A}*r_{C}. Similarly, the effective rate at which object B is animated, in terms of the global clock, is given by r_{eff}=r_{B}*r_{C}. If, for example, the rate r_{C} is equal to one, then the rotation of objects A and B is unaffected, i.e., they continue to rotate at their same respective rates.

However, if the rate associated with the local clock t_{C} is modified, then the animation of objects A and B can be adjusted. For example, if a user employs a user input device to double the rate r_{C} of local clock t_{C}, then the effective rate of the local clocks for objects A and B also will double. However, the relative rates at which local clocks t_{A} and t_{B} advance will remain the same. That is, even though the rotation of objects A and B increases due to the change in the rate of local clock t_{C}, object A will still appear to rotate twice as fast as object B.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage medium for execution by, or to control the operation of, data processing apparatus. The computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims. For example, multiple users could interact with the application at the same time. In some cases, multiple users could collaborate to modify animations and transform time-based drawings in a shared drawing space. Each user could employ a separate input device represented in the drawing space with a particular pointer icon. Alternatively, in some cases, multiple users may interact with the drawing application in separate drawing spaces that are simultaneously visible on a display. The users could interact with the drawing application in the same location or interact remotely with the drawing application over a network from separate areas. If each user is located in a different area, the animations generated by each user can be synchronized in the drawing spaced according to a single global clock or separate global clocks corresponding to each user. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving, from a user input device, user input defining a drawing, the drawing comprising a plurality of first object location coordinates received during a time period;
recording, for each first object location coordinate of the drawing, a corresponding temporal coordinate as the first object location coordinate is received from the user input device during the time period;
receiving an input defining an animation period;
applying a transformation to the first temporal coordinates to provide a plurality of transformed temporal coordinates respectively corresponding to the first object location coordinates; and
periodically generating, based on the animation period, an animation of the drawing by outputting the first object location coordinates to a display according to the respective transformed temporal coordinates.

2. The method of claim 1 wherein the plurality of first object location coordinates represent one or more locations in two-dimensional or three-dimensional image space.

3. The method of claim 1 wherein the transformation of the first temporal coordinates is applied in response to a user-initiated command received by the data processing apparatus.

4. The method of claim 1 wherein applying the transformation includes scaling at least one or more of the first temporal coordinates.

5. The method of claim 1 wherein applying the transformation includes translating at least one or more of the first temporal coordinates.

6. The method of claim 1 wherein applying the transformation includes rotating the first temporal coordinates.

7. The method of claim 1 further comprising:
generating one or more second temporal coordinates; and
interpolating, for each of the one or more second temporal coordinates, a respective second object location coordinate,
wherein generating the animation includes drawing the one or more second object location coordinates according to the respective one or more second temporal coordinates.

8. The method of claim 1 further comprising receiving an input defining a rate at which the plurality of first temporal coordinates are determined.

9. A non-transitory computer storage medium encoded with a computer program, the program comprising instructions that when executed by data processing apparatus cause the data processing apparatus to perform operations comprising:
receiving input defining a drawing, the drawing comprising a plurality of first object location coordinates received during a time period;
recording, for each first object location coordinate of the drawing, a corresponding temporal coordinate as the first object location coordinate is received from the user input device during the time period;
receiving an input defining an animation period;
applying a transformation to the first temporal coordinates to provide a plurality of transformed temporal coordinates respectively corresponding to the first object location coordinates; and
periodically generating, based on the animation period, an animation of the drawing by outputting the first object location coordinates to a display according to the respective transformed temporal coordinates.

10. The computer storage medium of claim 9 wherein the plurality of first object location coordinates represent one or more locations in two-dimensional or three-dimensional image space.

11. The computer storage medium of claim 9 wherein the transformation of the first temporal coordinates is applied in response to a user-initiated command received by the data processing apparatus.

12. The computer storage medium of claim 9 wherein applying the transformation includes scaling at least one or more of the first temporal coordinates.

13. The computer storage medium of claim 9 wherein applying the transformation includes translating at least one or more of the first temporal coordinates.

14. The computer storage medium of claim 9 wherein applying the transformation includes rotating the first temporal coordinates.

15. The computer storage medium of claim 9 further comprising instructions that when executed by data processing apparatus cause the data processing apparatus to perform operations comprising:
generating one or more second temporal coordinates; and
interpolating, for each of the one or more second temporal coordinates, a respective second object location coordinate,
wherein generating the animation includes drawing the one or more second object location coordinates according to the one or more respective second temporal coordinates.

16. The computer storage medium of claim 9 further comprising instructions that when executed by data processing apparatus cause the data processing apparatus to perform operations comprising receiving an input defining a rate at which the plurality of first temporal coordinates are determined.

17. A system comprising:
a device comprising a display;
an input device coupled to the device; and
one or more computers including data processing apparatus operable to interact with the device and to:
receive, from an input device, user input defining a drawing, the drawing comprising a plurality of first object location coordinates received during a time period;
record, for each first object location coordinate of the drawing, a corresponding temporal coordinate as the first object location coordinate is received from the user input device during the time period;
receive an input defining an animation period;
apply a transformation to the first temporal coordinates to provide a plurality of transformed temporal coordinates respectively corresponding to the first object location coordinates; and
periodically generate, based on the animation period, an animation of the drawing by outputting the first object location coordinates to a display according to the respective transformed temporal coordinates.

18. The system of claim 17 wherein the plurality of first object location coordinates represent one or more locations in two-dimensional or three-dimensional image space.

19. The system of claim 17 wherein the transformation of the first temporal coordinates is applied in response to a user-initiated command received by the data processing apparatus.

20. The system of claim 17 wherein applying the transformation includes scaling at least one or more of the first temporal coordinates.

21. The system of claim 17 wherein applying the transformation includes translating at least one or more of the first temporal coordinates.

22. The system of claim 17 wherein applying the transformation includes rotating the first temporal coordinates.

23. The system of claim 17 further comprising:
generating one or more second temporal coordinates; and
interpolating, for each of the one or more second temporal coordinates, a respective second object location coordinate,
wherein generating the animation includes drawing the one or more second object location coordinates according to the respective second temporal coordinates.

24. The system of claim 17 further comprising receiving an input defining a rate at which the plurality of first temporal coordinates are determined.
